(19) United States
(12) Patent Application Publication
(10) Pub. No.: US 2010/0219275 A1
(43) Pub. Date: Sep. 2, 2010

(54) Bale processing apparatus

(76) Inventor: Leonard D. Weiss, Brush, CO (US)

Correspondence Address: Dean P. Edmundson, P.O. Box 179, Burton, TX, 77835, US

(21) Appl. No.: 12/798,561

(22) Filed: Apr. 7, 2010

Related U.S. Application Data
(63) Continuation-in-part of application No. 11/820,309, filed on Jun. 19, 2007.
Application No. 11/820,309 is a continuation-in-part of application No. 11/243,616, filed on Oct. 5, 2005, now abandoned.
(60) Provisional application No. 60/618,673, filed on Oct. 14, 2004.

(51) Int. Cl. B02C 18/24; B02C 19/00; B02C 18/16

(52) U.S. Cl. 241/101.76; 241/282.1

(57) ABSTRACT

Bale processing apparatus is disclosed which includes an elongated bed for supporting bale of forage to be processed. Cutting blades are carried on transverse shafts at one end of the apparatus, and a conveyer advances the bale toward the cutting blades. The lowermost transverse shaft rotates opposite to the next adjacent transverse shaft. The cutting means further include an outwardly projecting blade to assist in cutting the forage material. In one embodiment, the cutting mill is tilted rearwardly.

### CROSS-REFERENCE TO RELATED APPLICATIONS

This application is a continuation-in-part of my earlier copending application Ser. No. 11/820,309, filed Jun. 19, 2007, which was a continuation-in-part of my earlier application Ser. No. 11/243,616, filed Oct. 5, 2005, which was based upon, and claims priority from, my Provisional Application No. 60/618,673, filed Oct. 14, 2004.

### FIELD OF THE INVENTION

This invention relates to equipment used for processing bales of forage such as hay or straw. More particulary, in one embodiment this invention relates to equipment which can be towed behind a tractor, or be truck-mounted, for processing large bales.

### BACKGROUND OF THE PRIOR ART

It is common for farmers, ranchers, dairies, feedlot operators, etc. to use large bales of forage such as hay or straw when feeding or bedding their animals. Large bales are sometimes also used for mulch when planting grass along roadways, for example, or for land reclamation.

Conventional bale processors include large tub grinders and also smaller units which can be towed behind a tractor. All of such equipment typically utilizes a rotating shaft having a number of spaced hammers along its length. The shaft is rotated at high speed so that the hammers are able to beat and tear the forage off the bale being processed. Unfortunately, this action also results in much of the forage being pulverized into very small pieces, thereby creating a considerable amount of dust which is very undesirable. Any dust particles which blow or drift away in the wind are lost. Furthermore, very small particles of forage fed to animals are not desirable as feed.

Although some prior patents describe tub grinders and the like for processing bales, none of such patents describes apparatus having the features provided by the apparatus of this invention. For example, U.S. Pat. No. 5,573,190 (Goosen) describes a round bale shredder involving three transverse shafts with cutting rotors or knives extending radially outward from each shaft. From the drawings, all of the shafts rotate in the same direction. Because of the design of his apparatus, the bale will be pushed up against the shafts, and the straight knives can only cut into the bale in specific locations. Thus, the knives he shows are very inefficient in shredding a bale; consequently, he requires the inclusion of an oscillating carriage for oscillating the bale across the cutting knives to induce further cutting action. Also, Goosen does not provide for dispensing cut material selectively to the left or the right side of the machine. In U.S. Pat. No. 5,255,867 (Whittleton) there is described a bale ripper which uses rotating hammers on opposite sides of a round bale. The ripped material is dropped onto a conveyer to move it to the rear of the machine. There is no description of the use of transverse shafts, nor does the machine provide for dispensing material to the left or the right side. U.S. Pat. No. 7,066,417 (LePage) describes a bale processor which uses a tub with rotating hammers or flails on a longitudinal shaft in the bottom. There are no transverse shafts with cutting blades nor is there means for dispensing material laterally. U.S. Pat. No. 4,428,537 (von der Heide) describes a silage wagon with a plurality of rollers for comminuting silage. It is not a bale processor. U.S. Pat. No. 3,999,674 (Meiti) refers to a bale loader and shredder in which spaced teeth on transverse shafts tear apart a bale on the bed. All of the shafts rotate in the same direction. The apparatus includes a module-lifting fork or ramp pivotally mounted on the rear of the load bed.

There has not heretofore been provided bale processor apparatus having the several advantages of the bale processor described herein. These advantages will become apparent from the detailed description and the accompanying drawings.

### BRIEF SUMMARY OF THE INVENTION

In accordance with the present invention there is provided a bale processor which avoids use of the hammers which are typically found on conventional bale processors. In accordance with one embodiment of the present invention there is provided bale processing apparatus which comprises:

(a) an elongated bed having first and second ends;

(b) mill means supported at the first end of the bed; wherein the mill means comprises at least two rotatably driven transverse shafts with a plurality of cutting means secured thereto; wherein one of said shafts is rotatably driven in a first direction and the other said shaft is rotatably driven in the opposite direction; wherein one of the shafts is vertically higher than the other said shaft;

(c) conveyer means on the bed for advancing a bale longitudinally along the bed toward the mill means;

(d) dispensing means adjacent the mill means for dispensing cut material from the bale laterally relative to the bed, i.e. the cut material is dispensed outwardly from one side of the bed or the other side, as desired.

The forage material in the bale is cut to a desired length (e.g. 3-12 inches) by the cutting blades or knives. Because the forage material is cut into a desired length, it is not ground into fine particles or powder. This avoids the formation of dust which typically results from the use of conventional tub grinders. The efficiency of the processor of this invention results in less horsepower and fuel requirements than are needed for operating other bale processors. There is also less maintenance and wear on the equipment. The types of cutting blades or knives may vary, and the spacing between adjacent blades or knives may also vary, as desired.

The cutting means used in the bale processor of this invention preferably also include a cutting edge or knife which projects outwardly from the side of the cutting means (e.g. at a 45° or 90° angle, for example). This arrangement provides for much more efficient cutting of the forage material. Also, the lowermost rotatable shaft at the forward end of the bed is rotated in a direction such that the forage material is lifted upwardly off the bed and then passed through the gap between the lowermost shaft and the adjacent shaft above it. This feature greatly increases the efficiency of the processing.

The bale processor can easily handle all types, sizes and shapes of forage material (e.g. small, medium or large square bales; round bales; or loose or loaf hay or straw) and requires significantly less horsepower than conventional processors. The bale processor of the invention also provides a better quality feed ration with longer stems which have good leaf to stem ratio (not just sticks and powder from over-processing). The cutting blades can also be easily changed, when desired, to meet the needs of each farmer, dairy, feedlot commercial grinding or reclamation service. By adding more cutting blades and increasing the run speed, the processor is also useful as a hay grinder.

### BRIEF DESCRIPTION OF THE DRAWINGS

FIG. 1 is a perspective view of one embodiment of bale processor of the present invention.

FIG. 2 is a front perspective view of the bale processor with a bale on the bed being engaged by the mill means of the processor.

FIG. 3 is a cross-sectional view of the bale processor illustrating the action of the mill means on a bale.

FIG. 4 is a side elevational view of the bale processor with three square bales on the bed.

FIG. 5 is a front isometric view of one embodiment of mill means useful in the apparatus of this invention.

FIG. 6 is an isometric view of one type of gear box useful in the apparatus of FIG. 5.

FIG. 7 is an isometric view illustrating the elongated bed and floor drive system.

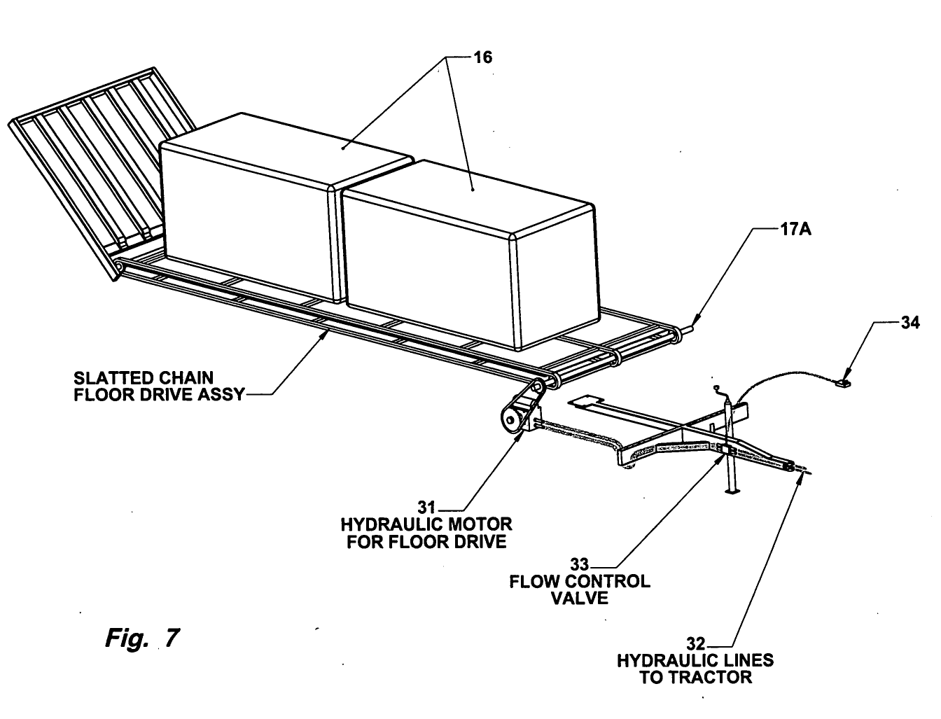

FIG. 8 is a front view illustrating the use of a fan to propel cut forage material outwardly from the discharge conveyer.

FIG. 9 is an isometric view of a preferred embodiment of cutting blade which is useful on the lowermost shaft in the mill means.

FIG. 10 is an isometric view of a preferred embodiment of cutting blade which is useful on the upper shaft of the mill means.

FIG. 11 is an isometric view of a preferred embodiment of a bottom lift shaft which is useful in the apparatus of this invention.

FIG. 12 is an isometric view of a preferred embodiment of an upper shaft with attached cutting blades.

FIG. 13 is an isometric view of a preferred type of cutting wheel useful on the lifter shaft 18.

FIG. 14 is an isometric view of the bottom lifter shaft with attached cutting wheels 120 as shown in FIG. 13.

FIG. 15 is an isometric view of a preferred type of cutting wheel 123 useful on the upper shafts 21 in the mill.

FIG. 16 is an isometric view of an upper shaft with attached cutting wheels 123 of the type shown in FIG. 15.

FIG. 17 is an isometric view of yet another type of cutting wheel which is useful in the processing apparatus of this invention.

FIG. 18 is a side elevational view of another type of cutting wheel useful in the apparatus of this invention.

FIG. 19 is a front elevational view of another embodiment of processing apparatus of the invention.

### DETAILED DESCRIPTION OF THE INVENTION

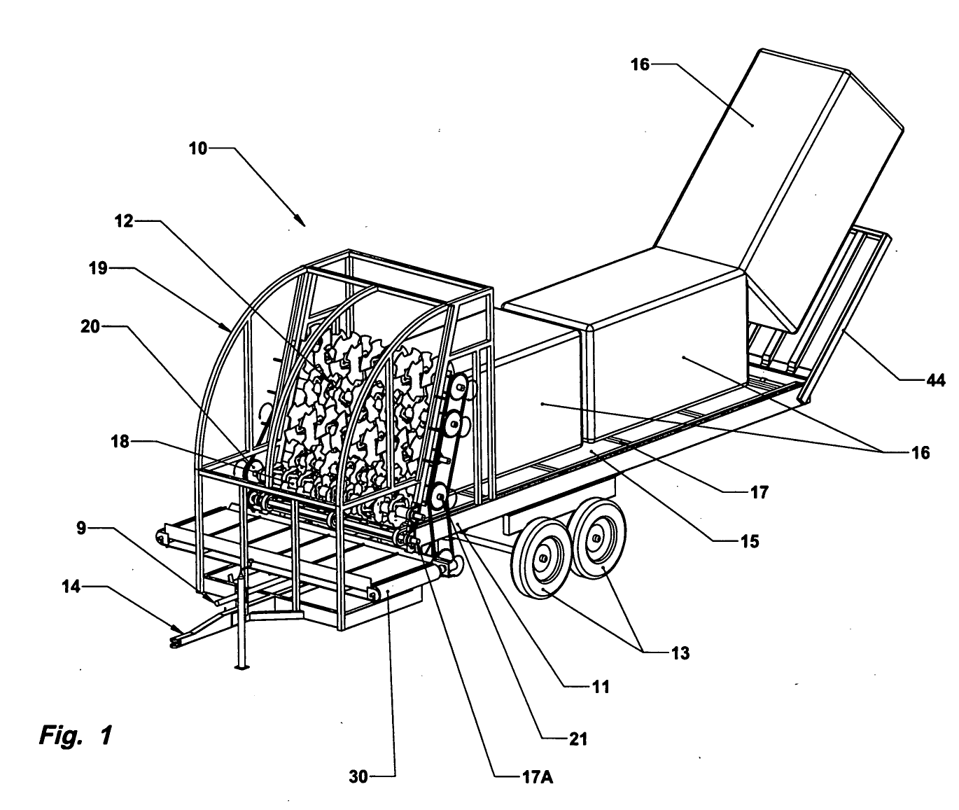

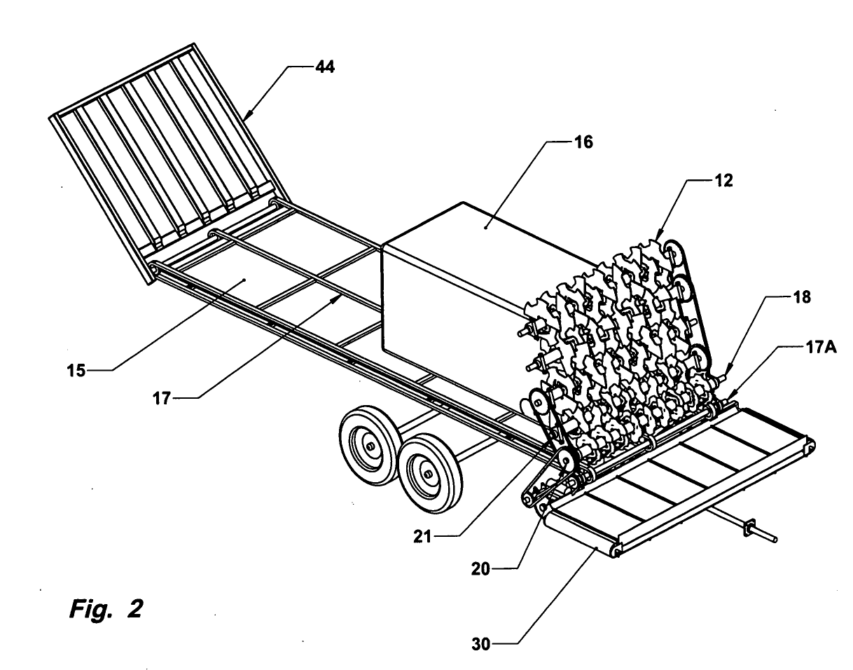

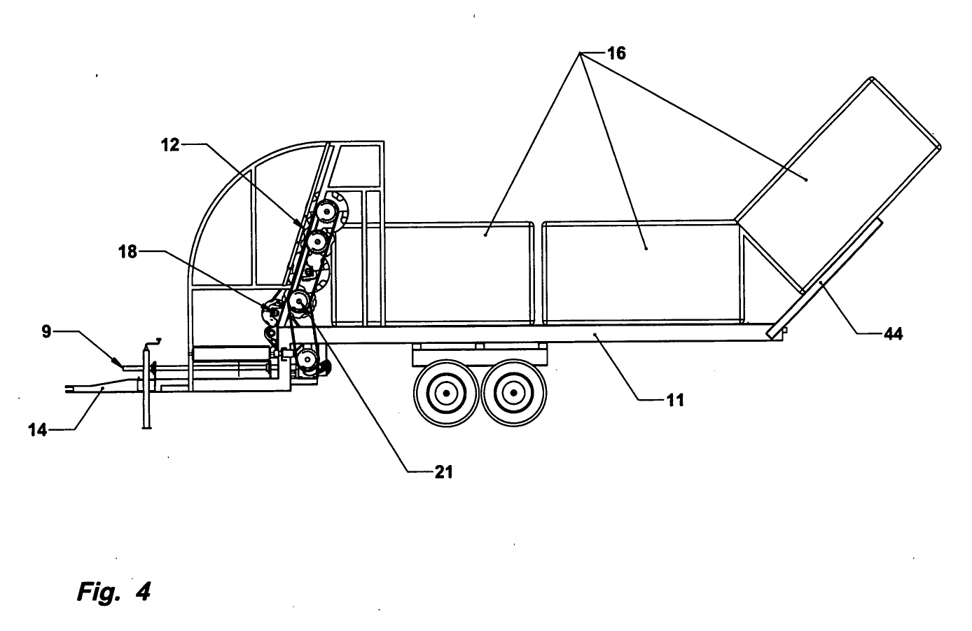

A preferred embodiment of the bale processor 10 of the present invention is illustrated in FIGS. 1-4. Portions of the front enclosure or shroud 19 normally shielding the mill means 12 on three sides have been removed to more clearly show the mill. The apparatus includes an elongated frame 11, carried on wheels 13, with hitch 14 for towing by a tractor. An elongated bed 15 rests on the frame for supporting large round or square bales 16 to be processed. The elongated bed includes a conveyer chain or apron 17 (driven by shaft 17A) for moving a bale longitudinally along the bed toward the cutting knives in the mill. Instead of using a chain conveyer, it is possible to use a continuous rubber belt. One advantage of using a rubber belt is that it will not become frozen to the bed in very cold temperatures. Also, a continuous belt prevents leaves and other small particles of forage from being lost prior to processing of the material.

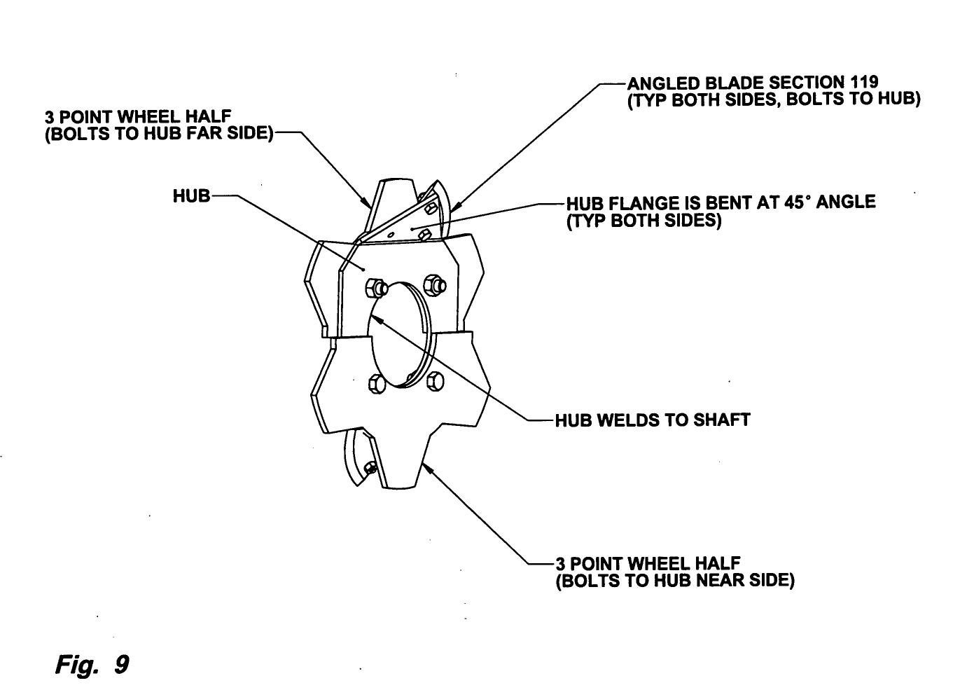

The mill means 12 comprises at least two, and preferably several, horizontal rotatable shafts extending transversely across the width of the bed. The lowermost shaft (sometimes referred to herein as the lift shaft or lifter shaft) is rotatably driven by gear 20 in a direction opposite to the direction in which adjacent shaft 21 is driven. On each shaft there are mounted a plurality of cutting wheels or blades, which are described in more detail below in connection with FIGS. 9-19.

Also included in the bale processor is a transverse conveyer or dispensing means 30. The transverse conveyer extends beneath the processing mill 12 at the forward end of the bed. Forage material which is cut loose from a bale falls downward onto the transverse conveyer where it is transported or conveyed laterally away from the bed (for example, it may be conveyed to a feedbunk alongside the processor). The width of the conveyer may vary, e.g. preferably from about 30 to 36 inches. Preferably, the transverse conveyer has a length greater than the width of the bed so that the conveyer extends laterally outward from each side of the bed (e.g. about 18 inches or so). It is also preferable for the transverse conveyer to be able to be driven in two directions (i.e. either to the left or to the right side of the bed 15) so that the conveyer can be used to fill a feedbunk on either side of the bed. Preferably, apron conveyer 17 is powered by a hydraulic motor 31 (via hydraulic lines 32 to the tractor, and electric flow control valve 33). Electric line 34 connects between the valve 33 and the tractor. This feature enables the operator to quickly and easily change the apron speed as desired during the processing of forage material.

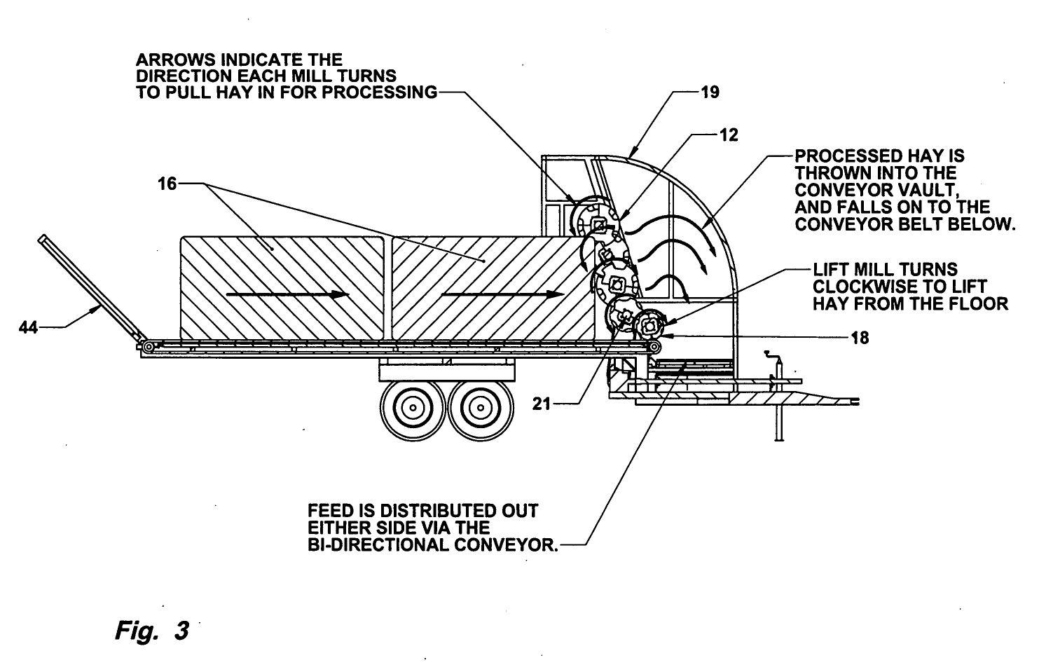

FIG. 3 is a cross-sectional view of the apparatus which illustrates the processing sequence of baled forage (e.g. hay or straw) going through the machine. The bales 16 are advanced toward the forward end of the elongated bed by means of the floor chain or conveyer. As the forward end of a bale encounters the mill 12, the knives on the rotatable shafts begin to cut the forage into small lengths (e.g. about 3 to 12 inches, depending upon the speed of the floor apron, mill rpm speed, and blade spacing on the shafts). The processed material then falls downwardly onto the transverse conveyer 30 where it is selectively conveyed either to the left or to the right side of the machine for discharge. As illustrated in FIG. 3, the lowermost shaft 18 in the mill is caused to be driven clockwise in such a manner that it lifts the forage from the floor of the bed. The rotatable shaft 21 which is adjacent to (and slightly above) shaft 18 rotates in the opposite direction. The combined action of these two shafts 18 and 21 causes the cut forage material to flow smoothly into the conveyer vault area where it can fall down onto the conveyer 30. If shafts 18 and 21 rotated in the same direction, the cut forage material would tend to plug up the mill, particularly when the forage material is wet or tough. For additional processing speed, it is possible to change the rotation of one of the upper shafts 21 so that it also rotates in a clockwise direction while the other shafts 21 rotate in a counter-clockwise direction. Preferably it is the second highest large mill shaft that is rotated in this manner so as to take one-half of the forage material through the gap between the second and third highest large mill shafts to relieve the burden on the lower lifter shaft 18. Therefore, horsepower requirements are reduced and the volume of processed material is increased. Also, all of the forage material becomes processed in this manner.

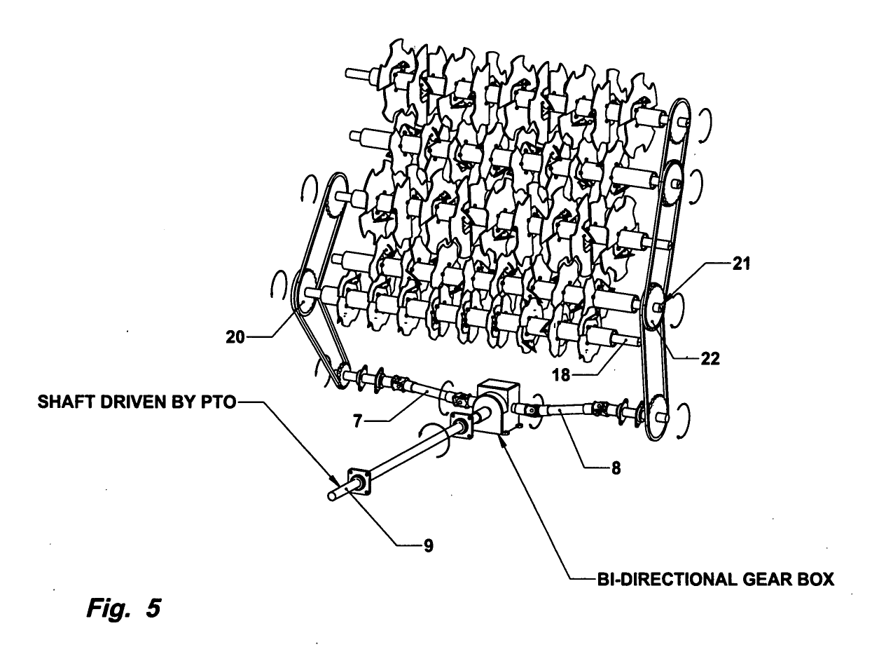

FIG. 5 is a front isometric view of the mill showing the manner in which it is powered by a power take-off shaft 9 connected to a tractor. This power shaft is connected to a bi-directional gear box, as shown. One side of the gear box drives a shaft 7 which operably connects to gear 20 to drive lift shaft 18. The other side of the gear box drives a shaft 8 which operably connects to gear 22 to drive shaft 21. Thus, shafts 18 and 21 rotate in opposite directions. This action is unique and is very desirable. The lower shaft 18 lifts the forage material up off the floor of the bed, and the next adjacent shaft 21 helps to push the cut forage material through to the conveyer vault area. Otherwise the forage material would be pinched between the lower shaft and the floor and is prevented from passing through the mill. In FIG. 5 the second highest upper shaft is shown as being driven in the same direction as the lifter shaft 18, as explained above, because it is sometimes desirable to drive one of the upper shafts in this manner so as to increase the processing capacity of the mill.

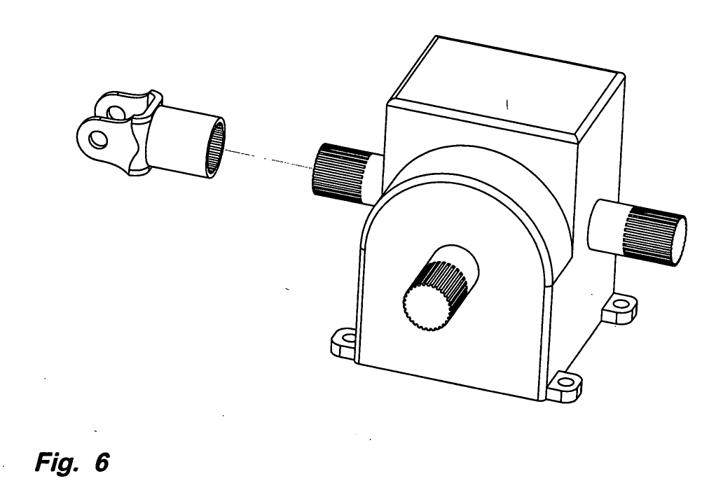

For ease of connection of the various shafts to the gear box, it is desirable for the shafts to be splined. This enables all shafts to be quickly and easily connected or disconnected, as needed. This is illustrated in FIG. 6.

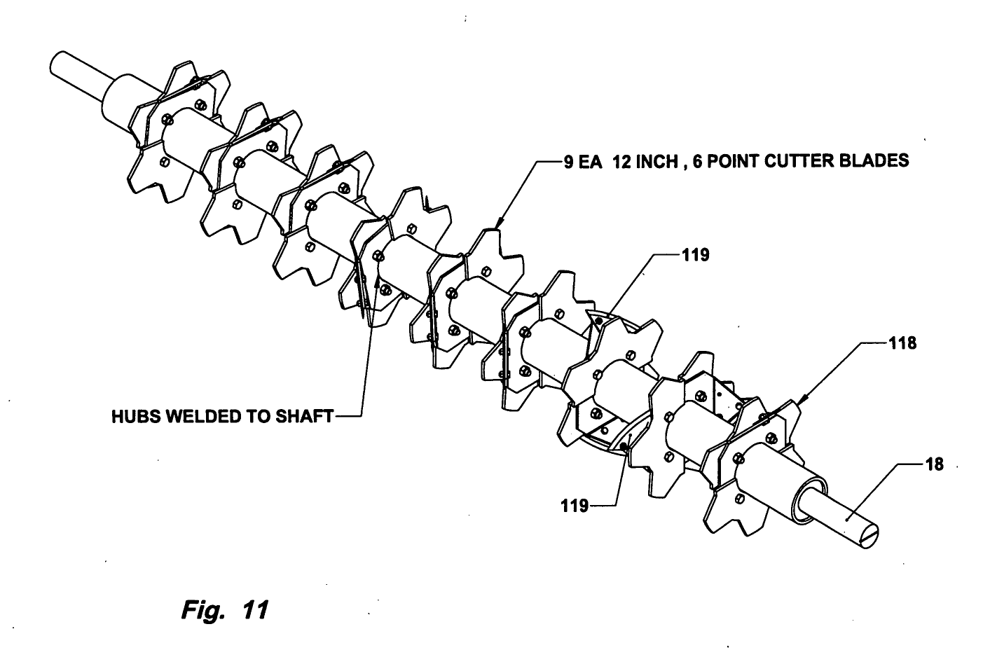

FIG. 9 illustrates a preferred type of cutting blade 118 used on the lift shaft 18 (the lowermost shaft in the mill). This cutting blade is composed of hardened steel, is preferably about 10 to 12 inches in diameter, and comprises two wheel or disk halves each having three points or notches on their outer edge. Each half is bolted to a hub section which is welded to the shaft 18. See FIG. 11. Each hub includes a flange which projects outwardly at a 45° angle, as shown. The flange on one hub section projects to one side, and the flange on the other hub section projects to the opposite side. Secured to each of such flanges is another cutting blade 119. These 45° blades act as kicker blades to push the cut forage material through the mill and into the conveyer area. The spacing between adjacent blades 118 on shaft 18 may be varied, as desired. For example, to increase the spacing between adjacent blades 118, some of the blade sections may be un-bolted from corresponding hub sections on the shaft.

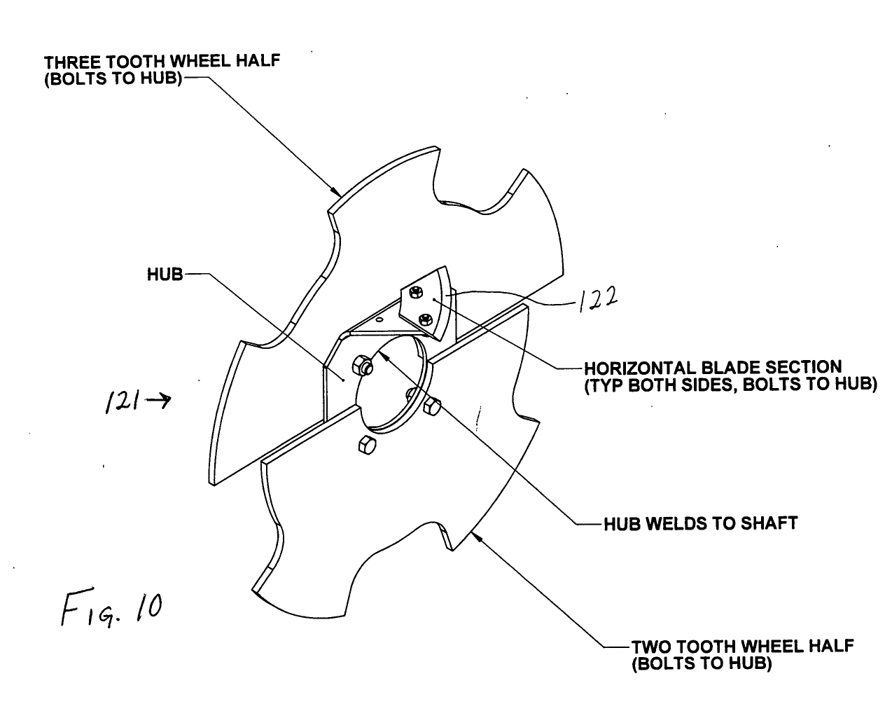

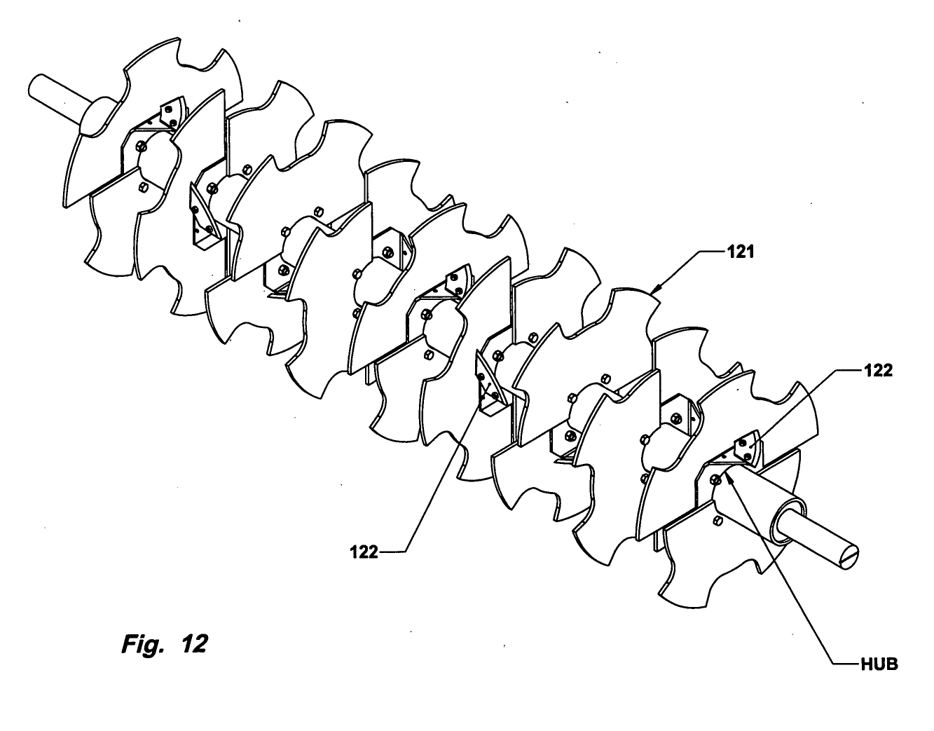

FIG. 10 illustrates a preferred type of cutting blade 121 useful on the upper shafts in the mill (e.g. shaft 21). This blade is preferably composed of hardened steel, and it comprises two disk sections having three points or notches. These blade sections are intended to be bolted to a hub which is to be welded to the shaft. See FIG. 12. The diameter of these blades 121 may be as large as about 24 inches or as small as about 16 inches, as desired. The spacing between adjacent blades on the same shaft may also vary. Each hub section includes a flange which projects outwardly at about a 90° angle (i.e. it is perpendicular to the main portion of the hub). Attached to each such flange by means of bolts is another cutting blade 122. The location of this cutting blade 122 is less than about half way between the shaft and the outer edge of blade 121. These kicker blades 122 assist in pushing the cut forage material through the mill and into the conveyer area.

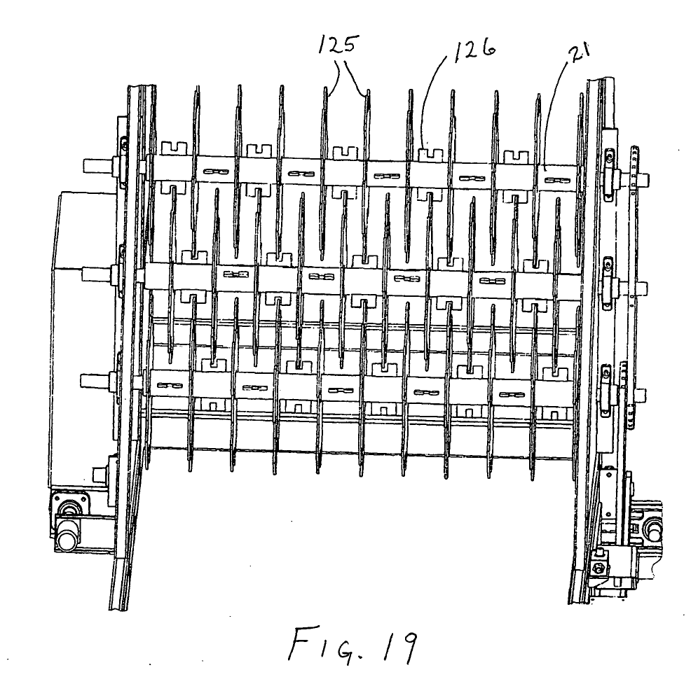

The speed of rotation of the blades and the shafts in the mill may vary (e.g. from about 250 rpm to about 500 rpm or even higher) to obtain the desired length of cut forage material. For some purposes, such as cutting hay into smaller particles, it may be desirable to operate at higher speeds. The blades on each shaft are preferably offset laterally about 6 inches from the blades on an adjacent shaft. It is also possible to include a plurality of kicker plates on the rotatable shafts, mid-way between adjacent cutting blades or knives for the purpose of kicking frozen chunks or lumps of forage backward toward the bale so that they can be processed further to reduce their size. This is illustrated in FIG. 19. The kicker plates 126 may be, for example, rectangular plates secured to the rotatable shaft 21 and being forced to rotate with the shaft. The peripheral edge of each cutting blade 125 passes through the notch on an adjacent shaft 21, as illustrated. Other configurations for a kicker plate may be used.

At the rearward end of the bed 15 there may also be included (as an option) a pivotable bed extension 44 for carrying one or more additional bales to be processed. This is shown in FIGS. 1-4. When the bales are carried on the extension, the extension may be in a nearly horizontal plane. Then when it is desired to move the bale(s) forward onto the apron 17 on the main part of the bed, the rear end of the extension may be simply raised (e.g. by means of a hydraulic cylinder). Because the front edge of the extension is pivotably attached to the rearward end of the bed, lifting of the extension 44 will cause the bale(s) to slide forward and be engaged by the apron on the bed. Preferably the extension 44 has a slatted floor so that dirt and debris sticking to the bale(s) can fall through the extension to the ground. Also the bed extension, when raised to an upright position, shortens the turning radius and improves operator visibility toward the rear of the apparatus.

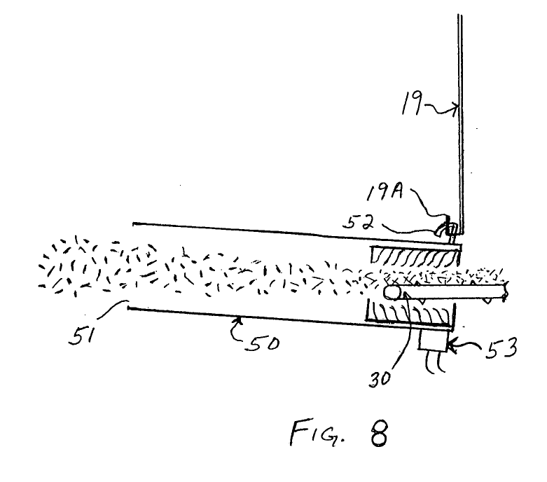

It is also possible for the bale processor to include a powered fan for blowing the processed forage material outwardly from the end of the transverse conveyer. This is illustrated in FIG. 8. The fan or blower may comprise a housing 50 with an elongated directional spout 51. The housing may also include appropriate hooks or fingers 52 to enable one end of the housing to be removably attached to the shroud 19 at the forward end of the apparatus (e.g. by engaging tabs 19A). The housing is sufficiently large that it will fit over the end of the transverse conveyer to be able to receive forage material from that conveyer. The blower or fan (which may be a turbine-type fan) is preferably powered by a hydraulic motor 53 appropriately connected to the hydraulic system of the tractor. Preferably the blower or fan can be attached to either end of the transverse conveyer so that the forage material may be blown outwardly from either side of the apparatus, as desired.

As is illustrated in FIGS. 1-4, the mill means 12 is tilted toward the rear of the apparatus, preferably at an angle of about 18°. In other words, the horizontal shafts with cutting wheels or blades are spaced progressively more toward the rear of the apparatus as the height from the floor increases. This eliminates any dead spots in the processor discharge system. Otherwise, flakes of a square bale will be processed one at a time, thereby creating a dead spot in the discharge system until the next flake is carried to the mill.

The number of rotatable shafts with cutting blades or knives may vary, depending upon the size of the bales being processed and the diameter of the cutting blades. Also, the diameter of the cutting blades may vary. The end of each shaft may be supported by a pillow block fastened to a vertical frame section. Preferably the shafts are cylindrical. The portion of the shaft which carries the cutting blades or knives is tubular and preferably is about 5-6 inches in diameter. The cutting blade sections are preferably bolted to hubs or collars which are in turn fastened to the shafts (e.g. by welding). Because the cutting blade sections are bolted to the hubs, it is possible to easily change the number or size of the blades, or the spacing between adjacent blades, to accommodate user needs, without disassembly of the entire processing mill. It is also possible to operate separate shafts at different rotational speeds, if desired.

The bale processor of this invention can be operated with a small tractor (e.g. about 45 horsepower). The processor can feed to the left or the right side into a feedbunk, or into a silo, or on the ground, into calving barns, dairy barns, use for reclamation purposes, etc. Forage material can be processed without destroying the quality of the material.

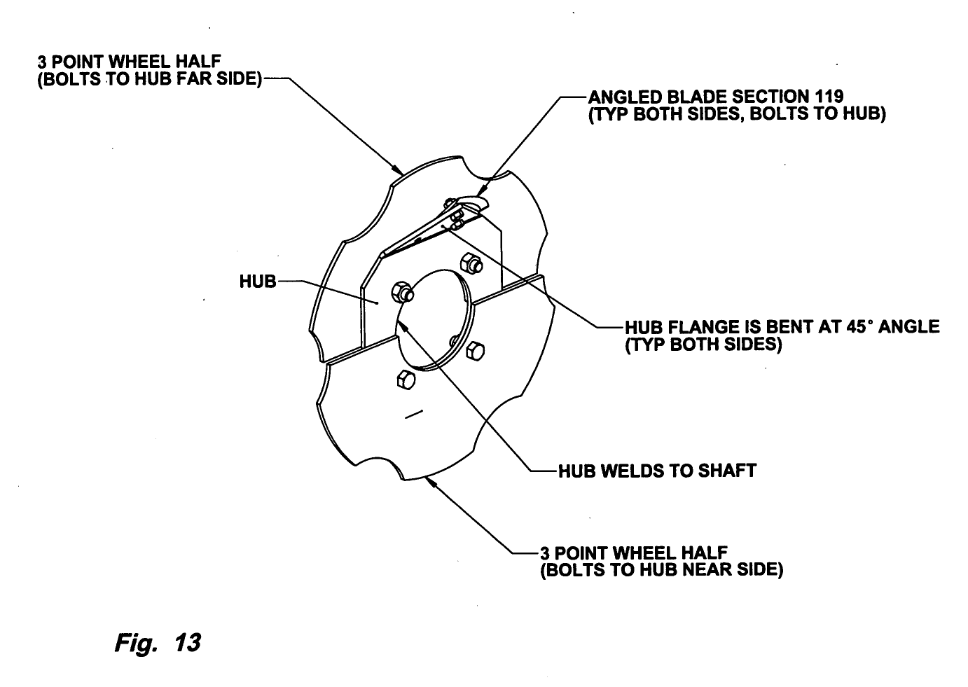

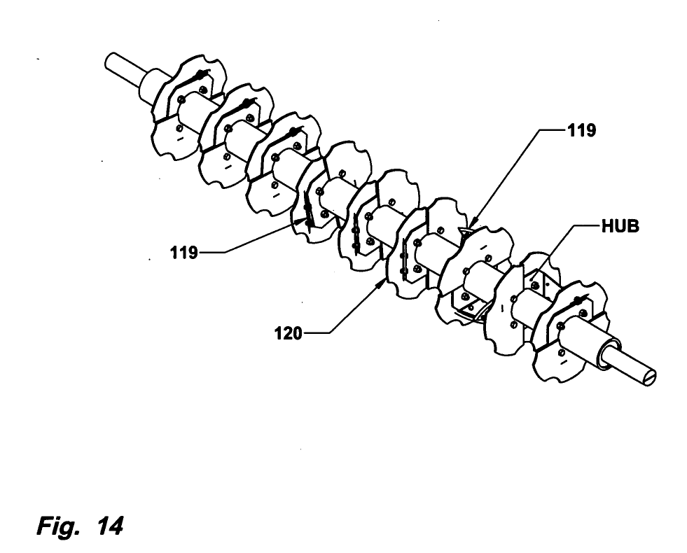

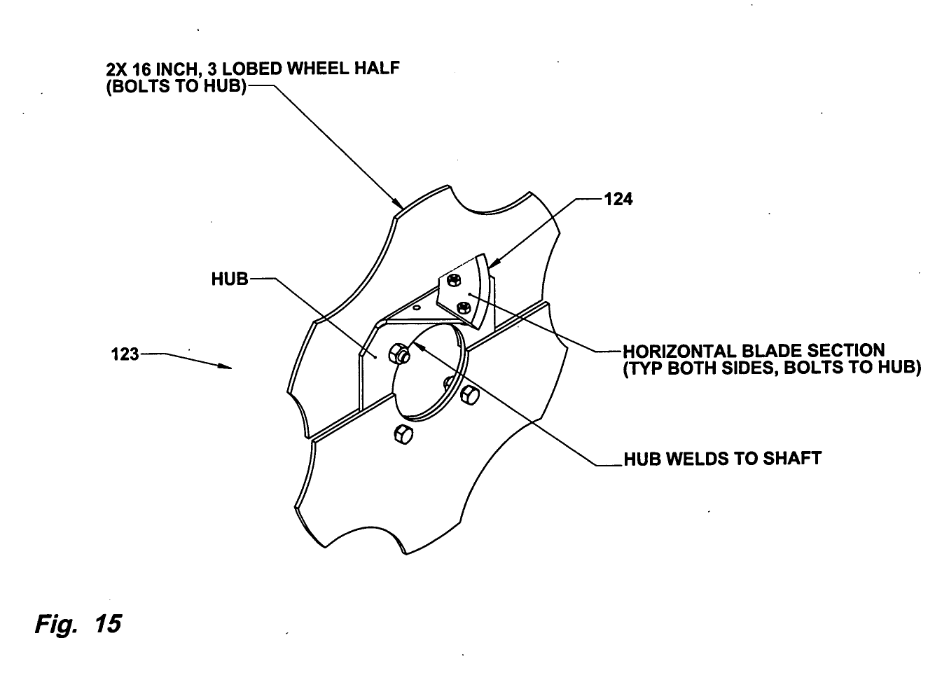

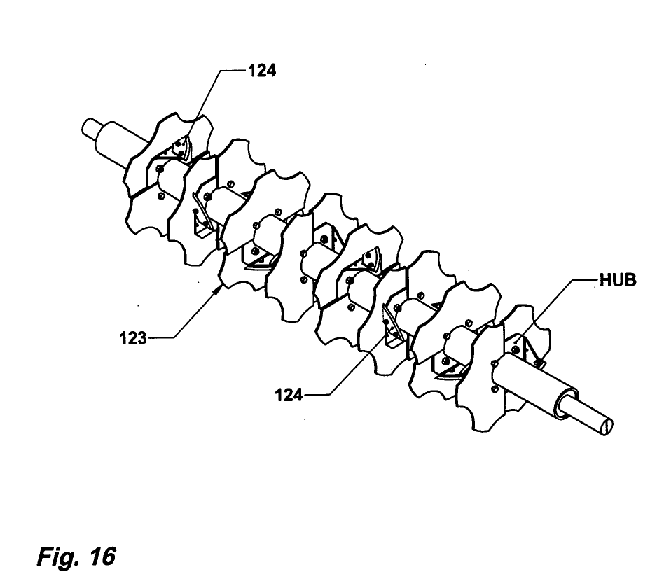

FIGS. 13 and 14 illustrate another embodiment of cutting wheel or disk which may be used in this invention (e.g. on a lifter shaft). This wheel has a peripheral edge which has been notched with half-moon notches. The cutting wheel includes two sections which can be separately bolted to a hub on a rotatable shaft. This cutting wheel has attached to each of its opposite sides an angled blade section 119 about mid-way between the shaft and the outer peripheral edge of the wheel, as shown. FIGS. 15 and 16 also illustrate another embodiment of cutting wheel or disk which may be used on the upper shafts in the processing apparatus. These disks have half-moon notches similar to those on the cutting wheels of FIG. 13.

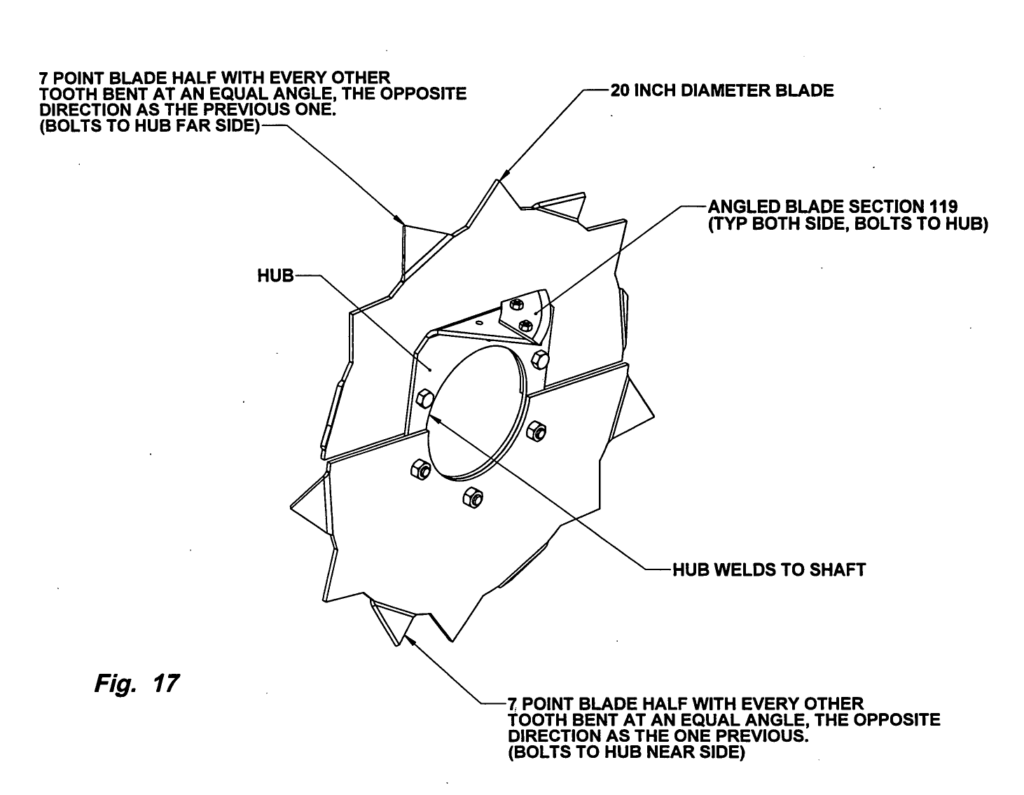

FIG. 17 is an isometric view of another embodiment of cutting wheel or disk which is useful in this invention. The periphery of this wheel includes sharp, pointed teeth which are alternatively tilted away from opposite sides of the planar surface of the blade. Also included is a separate blade section which is fastened to an outwardly projecting hub flange. This style of cutting blade or wheel is very aggressive in tearing apart forage material which must be processed.

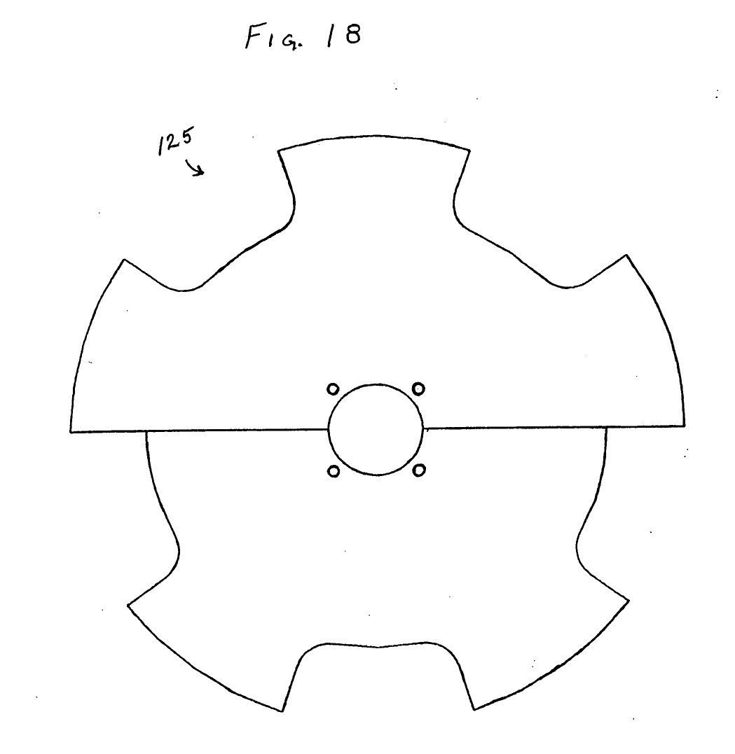

FIG. 18 is a side elevational view of another embodiment of cutting blade or wheel 125 which is useful in the apparatus of this invention. This cutting blade includes two sections which can be bolted or otherwise attached to a corresponding hub section on a rotatable shaft in the manner shown above. The periphery of each blade section is notched.

Other variants are possible without departing from the scope of this invention. For example, the elongated bed does not have to be mounted to a wheeled frame as shown. It may be mounted on a truck frame, for example. The bed may also be located in a fixed or stationary location (e.g. next to a barn or stack of bales to be processed). It is also possible for the processor to be powered by an electric or gas motor.

What is claimed is:

1. Bale processing apparatus comprising:
(a) an elongated bed having first and second ends for supporting a bale of forage to be processed;
(b) mill means supported at said first end of said bed; wherein said mill means comprises at least two rotatably driven transverse shafts with a plurality of cutting means secured thereto; wherein one of said shafts is rotatably driven in a first direction and the other said shaft is rotatably driven in the opposite direction; wherein one of said shafts is vertically higher than the other said shaft;
(c) conveyer means on said bed for advancing said bale longitudinally along said bed toward said mill means;
(d) dispensing means adjacent said mill means for dispensing cut material from said bale laterally relative to said bed; wherein said dispensing means is adapted to dispense said cut material selectively to the left or to the right side of said bed.

2. Apparatus in accordance with claim 1, wherein said dispensing means comprises a conveyer mounted below said mill means.

3. Apparatus in accordance with claim 1, wherein said cutting means comprises a plurality of disks each having a notched edge.

4. Apparatus in accordance with claim 3, wherein each said disk further includes a cutting blade projecting outwardly from at least one side of said disk.

5. Apparatus in accordance with claim 4, wherein said blade is perpendicular to said disk.

6. Apparatus in accordance with claim 1, wherein each said shaft is gear driven.

7. Apparatus in accordance with claim 1, wherein there are at least five rotatably driven transverse shafts each having a plurality of cutting means secured thereto; wherein said shafts are vertically separated from each other; wherein the first and third of said shafts are rotatably driven in a first direction and the second and fourth of said shafts are driven in a second direction.

8. Apparatus in accordance with claim 7, wherein said first shaft is positioned at said first end of said elongated bed; and wherein said second, third and fourth shafts are positioned progressively rearwardly from said first end of said elongated bed.

9. Apparatus in accordance with claim 1, further comprising a bed extension pivotably attached to said second end of said bed.

10. Apparatus in accordance with claim 9, wherein said bed extension is pivotable between lowered and raised positions.

11. Apparatus in accordance with claim 4, wherein said transverse shafts are carried by a vertical frame member.

12. Apparatus in accordance with claim 1, wherein said apparatus is powered by a PTO shaft.

13. Apparatus in accordance with claim 1, wherein said elongated bed further comprises conveyer means for advancing said bale toward said mill means.

14. Apparatus in accordance with claim 3, wherein each said shaft further comprises a plurality of hubs spaced therealong; and wherein said disks are bolted to said hubs.

15. Bale processing apparatus comprising:
(a) an elongated bed having first and second ends for supporting a bale of forage to be processed;
(b) mill means supported at said first end of said bed; wherein said mill means comprises at least five rotatably driven transverse shafts each having a plurality of cutting means secured thereto; wherein said shafts are vertically separated from each other; wherein the first and second of said shafts are rotatably driven in opposite directions;
(c) conveyer means on said bed for advancing said bale longitudinally along said bed toward said mill means;
(d) dispensing means adjacent said mill means for dispensing cut material from said bale laterally relative to said bed.

16. Apparatus in accordance with claim 15, wherein said first shaft is positioned at said first end of said elongated bed; and wherein said second, third, fourth and fifth shafts are positioned progressively rearwardly from said first end of said elongated bed.

17. Apparatus in accordance with claim 16, wherein said cutting means comprises a plurality of disks having a notched edge.

18. Apparatus in accordance with claim 16, wherein said disks further include a cutting blade projecting outwardly from at least one side of each said disk.

19. Apparatus in accordance with claim 16, wherein said mill means is tilted toward the rear of said elongated bed at an angle of about 18° from perpendicular.

20. Apparatus in accordance with claim 1, wherein said cutting means comprises a disk having a plurality of pointed teeth on its peripheral edge, wherein said teeth are tilted outwardly from said disk alternately away from opposite sides of said disk.
